(19) United States
(12) Patent Application Publication
(10) Pub. No.: US 2011/0032506 A1
(43) Pub. Date: Feb. 10, 2011

(54) EXPOSURE APPARATUS, SYSTEM, UPDATING METHOD, AND DEVICE MANUFACTURING METHOD

(75) Inventor: Shinichiro KOGA, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/853,585

(22) Filed: Aug. 10, 2010

(30) Foreign Application Priority Data
Aug. 10, 2009 (JP) 2009-186141

(51) Int. Cl. G03B 27/32; G06F 9/44

(52) U.S. Cl. 355/77; 717/171

(57) ABSTRACT

An exposure apparatus comprises a first interface connected to a communication network to which a control apparatus for performing a control operation of the exposure apparatus is connected, a second interface connected, not via the communication network, to an information processing apparatus which updates a software installed on the exposure apparatus, and a controller configured to control the first interface and the second interface so that communication of the first interface with the communication network is disabled, and thereupon communication of the second interface with the information processing apparatus is enabled to enable the information processing apparatus to update the software.

### BACKGROUND OF THE INVENTION

1. Field of the Invention

The present invention relates to an exposure apparatus, a system, a method of updating a software of an exposure apparatus, and a device manufacturing method.

2. Description of the Related Art

The performances and functions of apparatus for manufacturing various kinds of products have improved to keep up with improvements in performance and function of these various kinds of products.

Apparatus for manufacturing semiconductor devices such as an integrated circuit and a large-scale integration and liquid crystal panels will be taken as an example. The performance and function of exposure apparatus used to manufacture semiconductor devices have improved to keep up with advance in micropatterning and an increase in packing density of these products. Exposure apparatus called a stepper and a scanner are commonly used for this manufacture. These apparatus sequentially transfer a pattern formed on an original (e.g., a reticle) to a plurality of regions on a substrate (e.g., a wafer) while moving the substrate step by step. An apparatus which performs this transfer by full-field exposure without moving a stage is called a stepper, whereas that which performs this transfer while scanning a stage is called a scanner. An exposure apparatus including two wafer stages which hold substrates has recently been put into practical use to meet two demands for improvements in both overlay precision and throughput which are of prime importance for exposure apparatus. In addition, the development of an exposure apparatus which attains high-resolution transfer by filling the space between a substrate and a projection optical system which transfers an image of an original with a liquid has also progressed. In this manner, amid such improvements in precision and function of manufacturing apparatus typified by exposure apparatus, control software which controls the manufacturing apparatus is upgraded as needed so that it becomes more precise and sophisticated as well. Such software upgrading is often applicable not only to apparatus to be newly developed but also to manufacturing apparatus which have already been put into operation. Hence, upgrading (version upgrading) of the control software for active manufacturing apparatus is frequently performed.

A procedure for updating the control software of an exposure apparatus will be described as an example in which the control software of a conventional manufacturing apparatus is updated. FIG. 9 illustrates an example of a procedure for updating the control software of an exposure apparatus. The hardware configuration and necessary functions of the exposure apparatus are checked in advance to determine the version of control software to use (step S301). Next, a medium containing necessary control software is prepared (step S307). After steps S301 and S307 are executed in advance, the exposure process of the exposure apparatus whose control software is to be updated is stopped in step S303. A plant or a business establishment 1 (to be referred to as a plant 1 hereinafter) as the manufacturing location of a semiconductor manufacturing apparatus will be briefly described herein with reference to FIG. 10. An internal communication network 7 such as a local area network is formed in the plant 1, and a control apparatus 6 in the plant 1 performs scheduling and other control operations for an exposure apparatus 4 and other processing apparatus 5. Examples of the processing apparatus 5 are a developing apparatus and a machining apparatus. In step S303, the exposure process of the exposure apparatus 4 is stopped by canceling an exposure process request from the control apparatus 6 to the corresponding exposure apparatus 4. In step S308, the control software of the exposure apparatus 4 is updated. More specifically, the operator inserts a medium such as a magnetooptical disk or a flexible disk, which stores the control software, into the exposure apparatus 4, and performs operations such as updating condition setting and control software copying. See Japanese Patent Laid-Open No. 11-296352 for details of these operations. After the control software is updated, it is reflected by restarting the controller of the exposure apparatus 4. Lastly, the exposure apparatus 4 whose control software has been updated is tested in step S305. If no problem is found as a result of the test, an exposure process is started in step S306.

Japanese Patent Laid-Open Nos. 2000-188252, 10-97966, 11-15520 propose methods of updating the control software of the exposure apparatus 4 using a communication network such as the Internet or a local area network. In Japanese Patent Laid-Open No. 2000-188252, the control software of the exposure apparatus 4 is updated via the internal communication network 7 from the control apparatus 6 in the semiconductor device manufacturing plant described with reference to FIG. 10. Also, Japanese Patent Laid-Open Nos. 10-97966 and 11-15520 use communication security systems that prevent a third party from accessing classified information via the Internet.

Improvements in precision and function of a manufacturing apparatus by control software updating are effective to enhance the productivity of an active apparatus. On the other hand, since manufacturing apparatus such as an exposure apparatus are production facilities for manufacturing products, they are generally used without stopping all day. Thus, the downtime that is an operating time taken for processes, other than a manufacturing process, such as maintenance influences the user productivity. Control software updating is effective to raise the productivity from a long-term viewpoint, but temporarily degrades the productivity because the process of the manufacturing apparatus must be stopped while the control software is updated. Also, since a medium is used to provide control software, it takes a certain time to, for example, transfer the medium. In contrast to this, it takes a shorter time to update the control software in transferring and updating control software using a communication network such as various types of networks, but security problems and problems in operation are posed. In a method of updating the control software using a communication network, the control software is updated via the control apparatus 6 and the internal communication network 7 such as a local area network in the plant 1, as in the prior art described with reference to FIG. 10. A manufacturing apparatus generally has large-scale control software, and not the user but the manufacturing apparatus manufacturer (vendor) normally updates the control software. Hence, personnel of the vendor must use the control apparatus 6 and the internal communication network 7 in the plant 1, which are managed by the user, so he or she needs to exercise great caution in operation in order to ensure safety in terms of security.

### SUMMARY OF THE INVENTION

The present invention provides, for example, an exposure apparatus advantageous in terms of security.

According to the present invention, there is provided an exposure apparatus which exposes a substrate to radiant energy, the apparatus comprising: a first interface connected to a communication network to which a control apparatus for performing a control operation of the exposure apparatus is connected; a second interface connected, not via the communication network, to an information processing apparatus which updates a software installed on the exposure apparatus; and a controller configured to control the first interface and the second interface so that communication of the first interface with the communication network is disabled, and thereupon communication of the second interface with the information processing apparatus is enabled to enable the information processing apparatus to update the software.

Further features of the present invention will become apparent from the following description of exemplary embodiments with reference to the attached drawings.

### BRIEF DESCRIPTION OF THE DRAWINGS

FIG. 1 is a schematic block diagram of an exposure system according to the first embodiment;

FIG. 2 is a schematic block diagram showing an information processing apparatus;

FIG. 3 is a schematic block diagram showing an exposure apparatus;

FIG. 4 is a schematic view showing an exposure apparatus with a twin-stage configuration;

FIG. 5 is a flowchart showing a method of updating an exposure apparatus in the first embodiment;

FIG. 6 is a view illustrating an example of an operation window at the time of updating in the exposure apparatus;

FIG. 7 is a schematic block diagram showing an exposure system according to the second embodiment;

FIG. 8 is a schematic block diagram showing an exposure system according to the third embodiment;

FIG. 9 is a flowchart showing a method of updating an exposure apparatus in the prior art; and

FIG. 10 is a schematic block diagram showing an exposure system according to the prior art.

### DESCRIPTION OF THE EMBODIMENTS

### First Embodiment

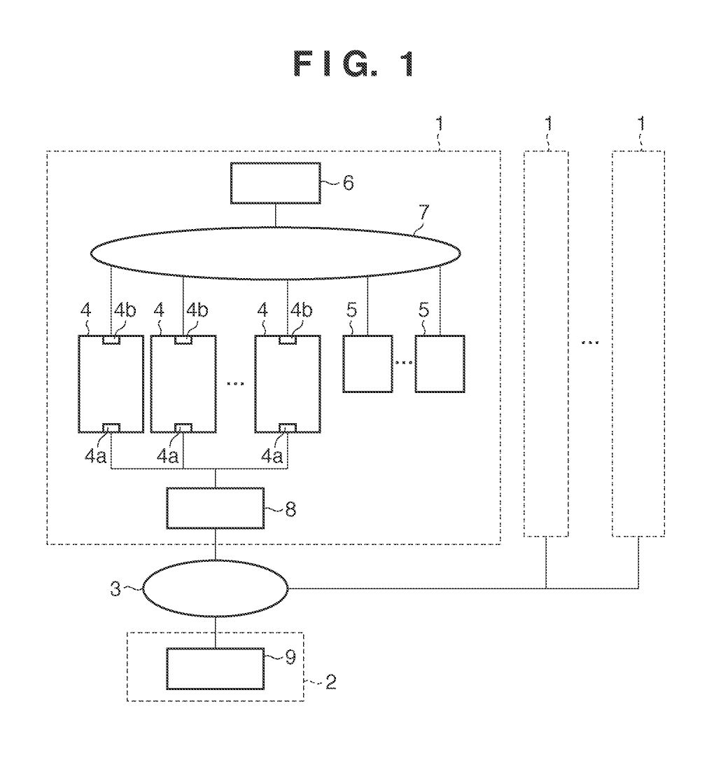

An exposure apparatus, an exposure system, and a method of updating the exposure apparatus according to the first embodiment will be described with reference to FIGS. 1 to 6. A plant or a business establishment (to be referred to as the “plant 1” hereinafter) as a semiconductor device manufacturing location, and a vendor facility 2 which manufactures, develops, and manages an exposure apparatus are connected to each other via an external communication network 3 such as the Internet. The plant 1 is equipped with one or more exposure apparatus 4, various types of processing apparatus 5, and a control apparatus 6. The control apparatus 6 produces semiconductor devices by controlling, for example, the exposure apparatus 4. Examples of the processing apparatus 5 are a developing apparatus and a machining apparatus. One or more exposure apparatus 4 are connected to a communication network 7 such as a local area network in the plant 1 via a first interfaces 4b, respectively. Not only the exposure apparatus 4 but also the processing apparatus 5 and other types of equipment (not shown) such as calculators present in the plant 1 can be connected to the communication network 7. Various types of equipment such as calculators present in the plant 1 strictly manage system security in the plant 1 in order to guard user's classified profiles against leakage. A first information processing apparatus 8 stores control software of the exposure apparatus 4. In this specification, “control software” includes not only software but also data associated with it. The first information processing apparatus 8 is connected to one or more exposure apparatus 4 via a second interfaces 4a, respectively, and updates the control software installed on the exposure apparatus 4 to new control software. The first information processing apparatus 8 is also connected to a second information processing apparatus 9, placed in the vendor facility 2, via the external communication network 3. The second information processing apparatus 9 stores the developed control software, including a latest version. The first information processing apparatus 8 is updated by copying target control software (e.g., latest control software) from the second information processing apparatus 9. This makes it possible to update the control software of the exposure apparatus 4 to target control software. The external communication network 3 which connects the first and second information processing apparatus 8 and 9 to each other may be a communication network which uses a private line, in place of a shared network such as the Internet. The external communication network 3 which uses a private line entails a cost higher than the Internet and other types of shared networks, but is advantageous from the viewpoint of security.

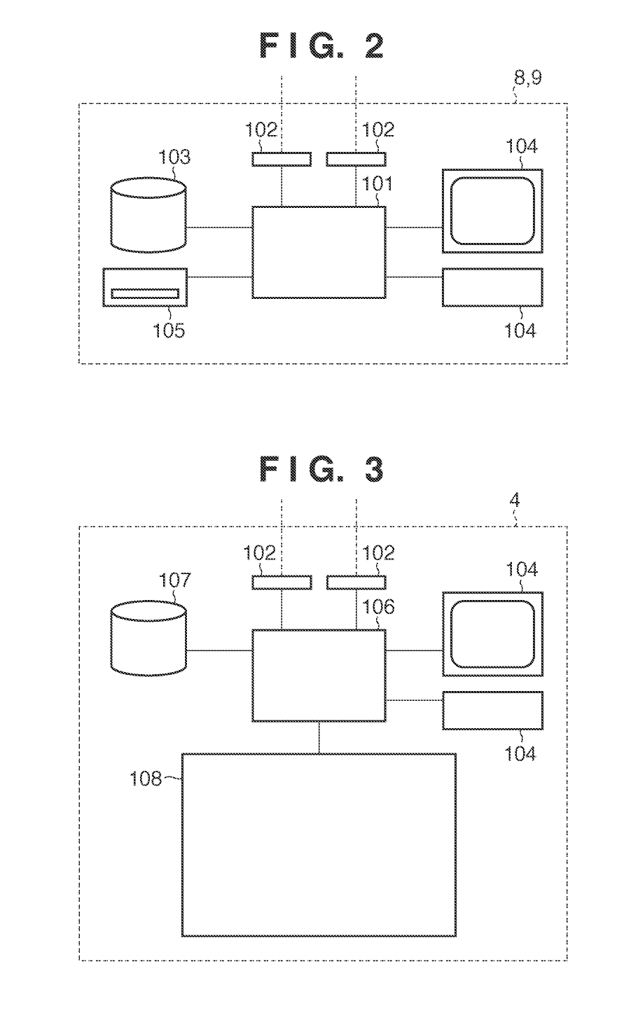

The first information processing apparatus 8 will be described next with reference to FIG. 2. The first information processing apparatus 8 includes a first controller 101, one or more first communication units 102, a first storage unit 103, one or more first consoles 104, and a first media drive 105. As an example, the first controller 101 can be a known calculator or board computer, and the first communication units 102 can be a known communication board. The first storage unit 103 can be a known hard disk, the first media drive 105 can be a known read/write device such as a magnetooptical disk, and the first consoles 104 can be, for example, a known monitor and keyboard. The first storage unit 103 holds control software which runs on the exposure apparatus 4. The first controller 101 transfers the control software held in the first storage unit 103 to the exposure apparatus 4 using one of the communication units 102 (e.g., upgrades the version of the control software). Also, the first controller 101 receives target control software from the second information processing apparatus 9 using another one of the communication units 102, and stores it in the first storage unit 103. The second information processing apparatus 9 includes a first controller 101, first communication units 102, a first storage unit 103, first consoles 104, and a first media drive 105, like the first information processing apparatus 8. The second information processing apparatus 9 transfers the control software held in the first storage unit 103 to the first information processing apparatus 8 using one of the first communication units 102. Note that the first and second information processing apparatus 8 and 9 ensure a given security, when they are connected to the external communication network 3, using a known technique such as a firewall, password management, or cryptography. To save the capacity of the first storage unit 103, the control software stored in the first and second information processing apparatus 8 and 9 may be compressed using a known method.

The exposure apparatus 4 will be described next with reference to FIG. 3. The exposure apparatus 4 includes a second controller 106, one or more first communication units 102, a second storage unit 107, one or more first consoles 104, and an exposure unit 108. The second controller 106 controls the exposure unit 108. As an example, the second controller 106 can be a known calculator or board computer. The second controller 106 controls the exposure unit 108 in accordance with the control software stored in the second storage unit 107. The second storage unit 107 can be, for example, a hard disk serving as an external memory, and the hard disk stores data using software or a database system. The second controller 106 is connected to the first information processing apparatus 8 via one of the first communication units 102, and to the communication network 7 via another one of the first communication units 102. One of the first communication units 102 serves as the second interface 4a connected to the first information processing apparatus 8, while another one of the first communication units 102 serves as the first interface 4b connected to the communication network 7. The second controller 106 switches the second interface 4a to a state, in which its communication with the first information processing apparatus 8 is enabled, only after setting the first interface 4b in a state in which its communication with the communication network 7 is disabled. That is, communication between the exposure apparatus 4 and the communication network 7 is disabled while the control software of the exposure apparatus 4 can be updated using the first information processing apparatus 8. Hence, system security can be reliably guarded because the first information processing apparatus 8 cannot access the control apparatus 6 and processing apparatus 5 in the semiconductor device manufacturing plant 1, which are connected to the communication network 7, via the exposure apparatus 4. Also, to confirm safety in terms of security, the exposure apparatus 4 can include a storage which stores a log of communication with the first information processing apparatus 8. Further, safety in terms of security can be improved by narrowing down the communication contents, sent from the first information processing apparatus 8 to the exposure apparatus 4, to, for example, items necessary to update the control software. In response to a control software update request from the first information processing apparatus 8, the second controller 106 switches the first interface 4b to a state in which communication between the communication network 7 and the exposure apparatus 4 is disabled. Only after communication between the communication network 7 and the exposure apparatus 4 is disabled, the second controller 106 switches the second interface 4a to a state in which communication between the first information processing apparatus 8 and the exposure apparatus 4 is enabled. Note that the second controller 106 can receive a control software update request from the first information processing apparatus 8 even when it has switched the second interface 4a to a state in which communication between the first information processing apparatus 8 and the exposure apparatus 4 is disabled. This can be done by setting a communication protocol. Alternatively, a communication line dedicated to transmission of the request from the first information processing apparatus 8 to the exposure apparatus 4 may be used. “A state in which communication between the first information processing apparatus 8 and the exposure apparatus 4 is enabled”, and “a state in which communication between the first information processing apparatus 8 and the exposure apparatus 4 is disabled” include such cases.

In the first embodiment, personnel of the vendor updates the control software of the exposure apparatus 4 using the first information processing apparatus 8. Hence, the personnel of the vendor need neither access the communication network 7 of the semiconductor device manufacturing plant 1 when he or she updates the control software of the exposure apparatus 4, nor devise a measure, which allows him or her to, for example, access the communication network 7 of the semiconductor device manufacturing plant 1. Further, since the second information processing apparatus 9 cannot access the communication network 7 of the semiconductor device manufacturing plant 1, either, safety in terms of security is high.

The exposure system according to this embodiment can quickly update the target control software by connecting the second information processing apparatus 9 in the vendor facility 2 and the exposure apparatus 4 to each other using the external communication network 3 via the first information processing apparatus 8. Also, because the external communication network 3 is not connected to the communication network 7 in the semiconductor device manufacturing plant 1, safety in terms of security is high for the communication network 7 in the semiconductor device manufacturing plant 1.

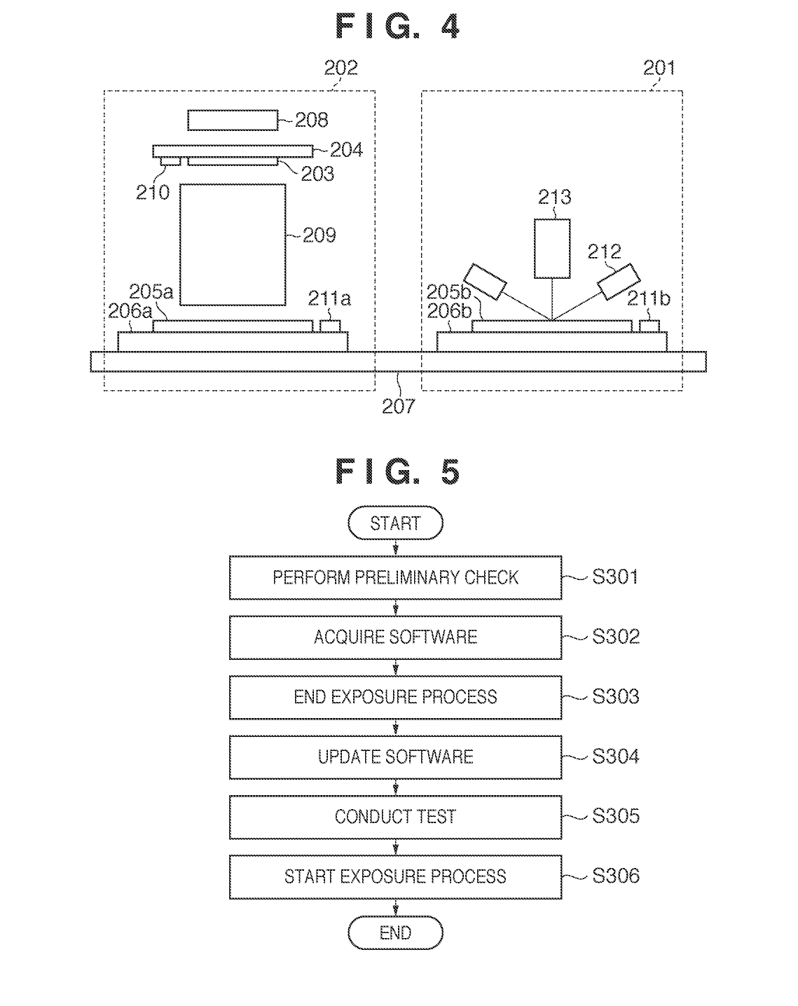

An exposure apparatus 4 with a twin-stage configuration, including two wafer stages that support substrates, will be described next with reference to FIG. 4. The exposure apparatus 4 with a twin-stage configuration includes a measurement station 201 and exposure station 202. The exposure station 202 includes a reticle stage 204 which supports a reticle 203, two wafer stages 206a and 206b which support wafers 205a and 205b and can move between the two stations, and a top plate 207 which supports the two wafer stages 206. The exposure apparatus 4 also includes an illumination optical system 208 which illuminates the reticle 203 supported by the reticle stage 204 with exposure light, and a projection optical system 209 which projects and transfers by exposure the pattern of the reticle 203 illuminated with exposure light onto the wafer 205a on the wafer stage 206. Although the exposure apparatus 4 shown in FIG. 4 uses two wafer stages 206, it may include one or three or more wafer stages 206.

A case in which the exposure apparatus 4 is a scanning exposure apparatus (scanner) which transfers by exposure a pattern formed on the reticle 203 onto the wafer 205 while moving the reticle 203 and the wafer 205 in synchronism with each other in the scanning direction will be explained as an example. The exposure apparatus 4 may be a full-field transfer exposure apparatus (stepper), as a matter of course. In the following description, a direction which coincides with the optical axis of the projection optical system 209 is defined as the Z-axis direction, the direction (scanning direction) to move the reticle 203 and the wafer 205 in synchronism with each other within a plane perpendicular to the Z-axis direction is defined as the Y-axis direction, and a direction (non-scanning direction) perpendicular to both the Z- and Y-axis directions is defined as the X-axis direction. Also, rotation directions about the X-, Y-, and Z-axes are defined as the θX, θY, and θZ directions, respectively.

A predetermined illumination region on the reticle 203 is illuminated with exposure light having a uniform illuminance distribution by the illumination optical system 208. Although the exposure light emitted by the illumination optical system 208 generally is light of a mercury lamp, KrF excimer laser, ArF excimer laser, or F₂ laser, or EUV (Extreme Ultra Violet) light, it may be another exposure light. The reticle stage 204 supports the reticle 203. The reticle stage 204 can two-dimensionally move within a plane perpendicular to the optical axis of the projection optical system 209, that is, within the X-Y plane, and finely rotate in the OZ direction. The reticle stage 204 is driven by a reticle stage driving device (not shown) such as a linear motor, which is controlled by the second controller 106 shown in FIG. 3. A mirror is mounted on the reticle stage 204. A laser interferometer (not shown) is set at a position opposite to the mirror. The laser interferometer measures a rotation angle θZ and the position, in the two-dimensional direction within the X-Y plane, of the reticle 203 on the reticle stage 204 in real time, and outputs the measurement results to the second controller 106. The second controller 106 positions the reticle 203, supported by the reticle stage 204, by driving the reticle stage driving device based on the measurement results obtained by the laser interferometer. The projection optical system 209 projects and transfers by exposure the pattern of the reticle 203 to the wafer 205 at a predetermined projection magnification β, and includes a plurality of optical elements, which are supported by a holder such as a metal member. In this embodiment, the projection optical system 209 is a reduction projection system with a projection magnification β of, for example, ¼ or ⅕.

Each wafer stage 206 supports the wafer 205, and includes a Z stage which holds the wafer 205 via a wafer chuck, an X-Y stage which supports the Z stage, and a base which supports the X-Y stage. The wafer stage 206 is driven by a wafer stage driving device (not shown) such as a linear motor. The wafer stage driving device is controlled by the second controller 106. A mirror which moves together with the wafer stage 206 is mounted on the wafer stage 206. A laser interferometer (not shown) is set at a position opposite to the mirror. The laser interferometer measures a rotation angle θZ and the position, in the X and Y directions, of the wafer stage 206 in real time, and outputs the measurement results to the second controller 106. The laser interferometer also measures rotation angles θX and θY and the position, in the Z direction, of the wafer stage 206 in real time, and outputs the measurement results to the second controller 106. The second controller 106 positions the wafer 205, supported by the wafer stage 206, by adjusting the position of the wafer 205 in the X, Y, and Z directions by driving the X-Y stage and the Z stage via the wafer stage driving device based on the measurement results obtained by the laser interferometer. A reticle alignment detection system (not shown) is formed near the reticle stage 204. The reticle alignment detection system detects stage reference marks 211a and 211b on the wafer stages 206 via the projection optical system 209 and a reticle reference mark 210 formed on the reticle stage 204. The stage reference marks 211 are aligned with respect to the reticle reference mark 210 using the reticle alignment detection system.

The measurement station 201 includes a focus detection system 212 which detects the surface position information (the position information in the Z-axis direction and the tilt information) of the wafer 205. The measurement station 201 also includes a wafer alignment detection system 213 which detects the positions of the wafer 205 and stage reference mark 211. The focus detection system 212 includes a light-projecting system which projects detection light onto the surface of the wafer 205, and a light-receiving system which receives the light reflected by the wafer 205. The detection results (measurement values) obtained by the focus detection system 212 are output to the second controller 106. The second controller 106 adjusts the tilt angle and the position (focus position), in the Z-axis direction, of the wafer 205, held by the Z stage, by driving the Z stage based on the detection results obtained by the focus detection system 212. The position detection results (measurement values) of the wafer 205 and stage reference mark 211 obtained by the wafer alignment detection system 213 are output to the second controller 106 as alignment position information within a coordinate system defined by the laser interferometer. The stage reference mark 211 is placed nearly flush with the surface of the wafer 205, and has its position detected by the reticle alignment detection system and the wafer alignment detection system 213, as shown in FIG. 4. Also, the stage reference mark 211 has a surface including a flat portion, which is used as a reference surface for the focus detection system 212. Stage reference marks 211 may be arranged at a plurality of corners of the wafer stage 206. The wafer 205 includes a plurality of wafer alignment marks detected by the wafer alignment detection system 213. The plurality of wafer alignment marks are formed on the peripheries of respective shot regions defined on the wafer 205, and the positional relationships (in the X and Y directions) of the wafer alignment marks and the shot regions are assumed to be known.

Such an exposure apparatus with a twin-stage configuration, for example, performs an exposure process for a first wafer 205 on the wafer stage 206 in the exposure station 202, while it loads a second wafer 205 onto the wafer stage 206 in the measurement station 201 and performs a measurement process for the second wafer 205 on the wafer stage 206 in the measurement station 201. After the respective operations are completed, the wafer stage 206 in the exposure station 202 moves to the measurement station 201, while the wafer stage 206 in the measurement station 201 moves to the exposure station 202 and an exposure process is performed for the second wafer 205.

An exposure method in this embodiment will be described next. After a wafer 205 is loaded into the measurement station 201, the stage reference mark 211 is detected by the wafer alignment detection system 213. To do this, the second controller 106 moves the wafer stage 206 while monitoring the output from the laser interferometer so that the optical axis of the wafer alignment detection system 213 is present on the stage reference mark 211. In this way, the wafer alignment detection system 213 measures the position information of the stage reference mark 211 within a coordinate system defined by the laser interferometer. In the measurement station 201 as well, the focus detection system 212 detects the surface position information of the stage reference mark 211. The position of each shot region on the wafer 205 is detected next. The second controller 106 moves the wafer stage 206 while monitoring the output from the laser interferometer so that the optical axis of the wafer alignment detection system 213 runs through the wafer alignment marks present on the peripheries of respective shot regions on the wafer 205. In the process of the movement, the wafer alignment detection system 213 detects the wafer alignment marks formed on the peripheries of shot regions defined on the wafer 205. In this way, the position of each wafer alignment mark within a coordinate system defined by the laser interferometer is detected. The positional relationship between the stage reference mark 211 and each wafer alignment marks is obtained based on the detection result of the stage reference mark 211 and each wafer alignment mark obtained by the wafer alignment detection system 213. Since the positional relationship between each wafer alignment mark and each shot region is known, that between the stage reference mark 211 and each shot region on the wafer 205 within the X-Y plane is determined. The focus detection system 212 detects surface position information of the wafer 205 for all shot regions defined on the wafer 205. The detection results are stored in the second controller 106 in correspondence with the position in the X and Y directions within a coordinate system defined by the laser interferometer. The positional relationship between the surface of a stage reference plate 214 and the surface of each shot region defined on the wafer 205 is determined based on the detection result of the surface position information of the stage reference mark 211 and the surface position information of each shot region defined on the wafer 205, which is obtained by the focus detection system 212.

Based on the results of the measurement process for the wafer 205 in the measurement station 201, the wafer 205 is exposed in the exposure station 202. The second controller 106 moves the wafer stage 206 so that the stage reference mark 211 can be detected using the reticle alignment detection system. The reticle alignment detection system detects the stage reference mark 211 via the reticle reference mark 210 and projection optical system 209. That is, the positional relationships between the reticle reference mark 210 and the stage reference mark 211 in the X and Y directions and in the Z direction are detected via the projection optical system 209. In this way, the position of a reticle pattern image projected onto the wafer 205 by the projection optical system 209 is detected using the stage reference mark 211 via the projection optical system 209. After the position detection of a reticle pattern image formed by the projection optical system 209 is completed, the second controller 106 moves the wafer stage 206 to move each shot region on the wafer 205 to a position below the projection optical system 209 in order to expose these shot regions on the wafer 205. A scan exposure of each shot region on the wafer 205 is performed using the corresponding measurement results obtained in the measurement station 201. During the exposure, each shot region on the wafer 205 and the reticle 203 are aligned with each other based on the positional relationship between the stage reference mark 211 and each shot region, which is obtained in the measurement station 201, and the relationship between the position of the stage reference mark 211 and the position to which a reticle pattern image is projected, which is obtained in the exposure station 202. The positional relationship between the stage reference mark 211 and each shot regions is obtained in the measurement station 201, and the relationship between the position of the stage reference mark 211 and the position to which a reticle pattern image is projected is obtained in the exposure station 202. Also, during the scan exposure, the positional relationship between the surface of the wafer 205 and the plane onto which a reticle pattern image is projected by the projection optical system 209 is adjusted. This adjustment is performed based on the positional relationship between the surface of the stage reference mark 211 and the surface of the wafer 205, which is obtained in the measurement station 201, and that between the surface of the stage reference mark 211 and the plane on which a reticle pattern image is formed by the projection optical system 209, which is obtained in the exposure station 202.

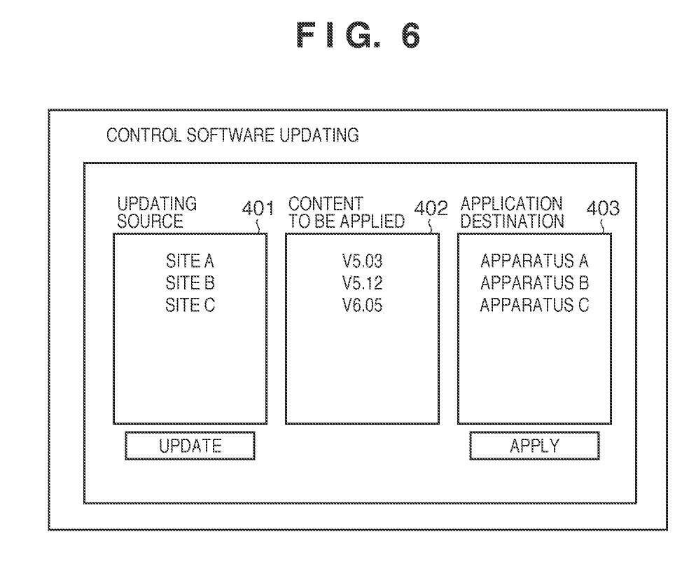

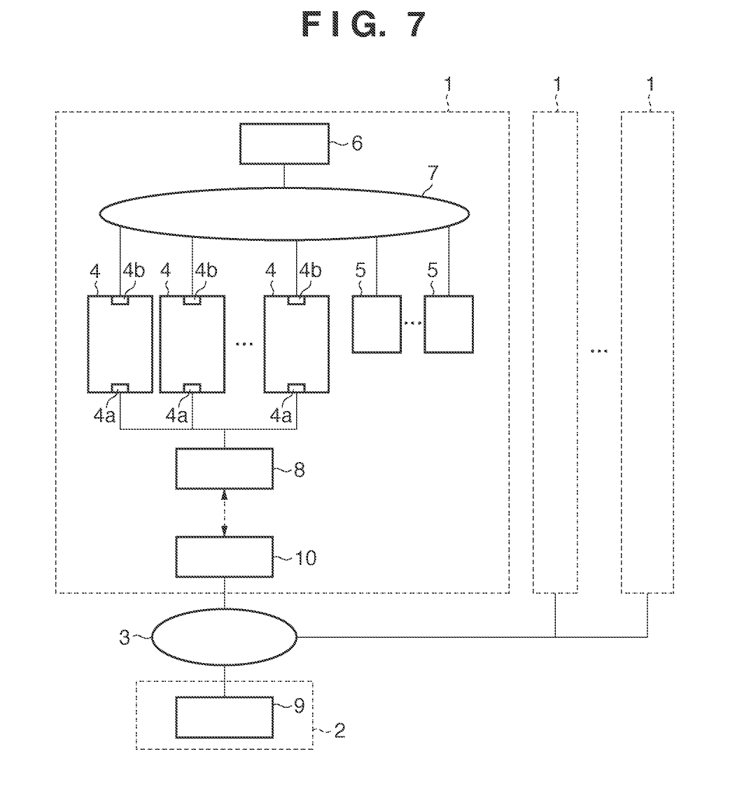

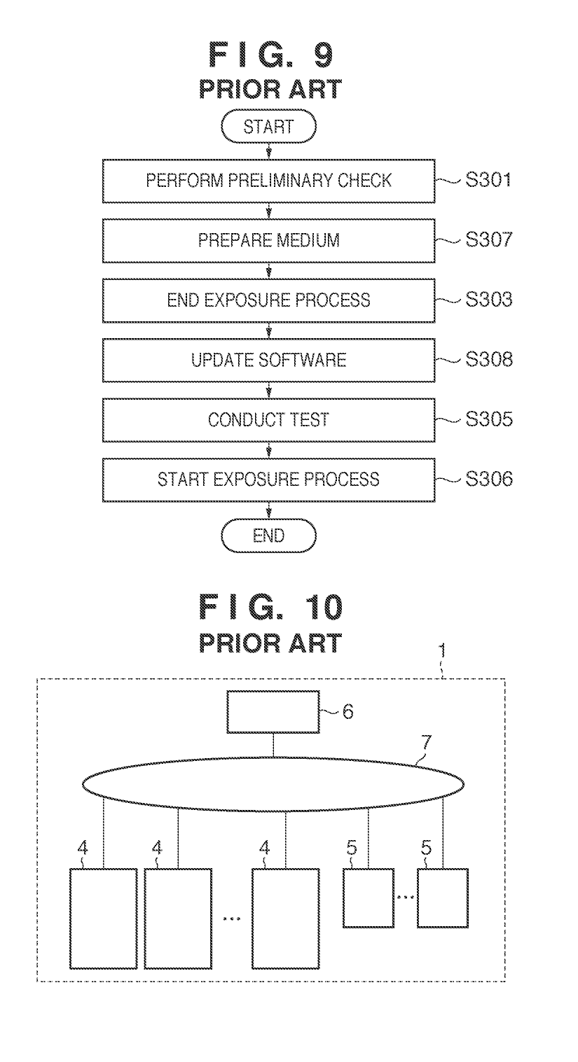

A method of updating the control software of the exposure apparatus 4 in the above-mentioned exposure system will be described next with reference to FIG. 5. Step S301 in which a preliminary check is performed, step S303 in which the exposure process is stopped, step S305 in which a test is conducted, and step S306 in which an exposure process is started are the same as in the prior art described with reference to FIG. 9, and a description thereof will not be given. In step S302, the first information processing apparatus 8 acquires new control software for use in updating, prior to updating the control software of the exposure apparatus 4. In the exposure system according to this embodiment, since the first information processing apparatus 8 is connected to the second information processing apparatus 9 via the external communication network 3, it can easily, quickly acquire target control software from the second information processing apparatus 9. In step S304 after the exposure process is stopped, the first information processing apparatus 8 updates the control software of the exposure apparatus 4 using the new control software acquired in step S302. FIG. 6 illustrates an example of the monitor window of the first information processing apparatus 8, through which new control software is acquired and the control software installed on the exposure apparatus 4 is updated to the new control software. The operator can use a region 401 to select and issue an update instruction to a second information processing apparatus 9 to which the first information processing apparatus 8 is connected at the time when the contents stored in the first information processing apparatus 8 are updated. Also, the operator can use a region 402 to designate the version of control software to use, and use a region 403 to select and issue an update instruction to an exposure apparatus whose control software is to be updated. In this manner, the operator can perform operations corresponding to medium preparation and control software updating in the prior art by operating the first information processing apparatus 8. Because dust and other particles cause product defects in the manufacture of, for example, semiconductors, semiconductor device manufacturing apparatus such as the exposure apparatus 4 are installed in a clean room of the semiconductor device manufacturing plant 1. It is a common practice to perform an operation for updating the control software for the exposure apparatus 4 in a clean room. However, since the first information processing apparatus 8 need not be installed in a clean room, the operation in a clean room can be omitted in this embodiment. In this manner, in this embodiment, a process of updating the exposure apparatus 4 can be performed with an operation quicker and simpler than in the prior art in which the control software of the exposure apparatus 4 is updated via a medium. Also in this embodiment, the target control software can be updated with an easy operation.

As has been described above, an exposure system including the exposure apparatus 4, and a method of updating the control software of the exposure apparatus 4 can update the control software of the exposure apparatus 4 with an easy operation while improving safety in terms of security for the use of the communication network 7.

### Second Embodiment

An exposure system including an exposure apparatus 4, and a method of updating the control software of the exposure apparatus 4 according to the second embodiment will be described with reference to FIG. 7. In the second embodiment, a first information processing apparatus 8 is connected to only one or more exposure apparatus 4. A third information processing apparatus 10 connected to a second information processing apparatus 9, placed in a vendor facility 2, via an external communication network 3 is placed in a plant 1. The first information processing apparatus 8 and third information processing apparatus 10 exchange control software using a medium such as a magnetooptical disk or a flexible disk. The system configuration is the same as in the first embodiment except for an information processing apparatus, and a description thereof will not be given. The second information processing apparatus 9 is also the same as in the first embodiment except that its connection destination changes from the first information processing apparatus 8 to the third information processing apparatus 10. The third information processing apparatus 10 receives target control software from the second information processing apparatus 9 via the external communication network 3. The operator writes the control software received by the third information processing apparatus 10 on a medium via a medium drive. The first information processing apparatus 8 reads information on the medium from the medium drive to acquire new control software. The first information processing apparatus 8 updates the control software of the exposure apparatus 4 by communicating with the exposure apparatus 4 via a second interface 4a of the exposure apparatus 4. In the second embodiment, the exposure apparatus 4 is connected to neither the second information processing apparatus 9 nor the external communication network 3, and acquires control software transferred using a transportable medium. Hence, an operation for updating the control software of the exposure apparatus 4 is more complicated but safety in terms of system security can be higher in the second embodiment than in the first embodiment.

A method of updating the control software of the exposure apparatus 4 in the second embodiment will be described next with reference to FIG. 5, as in the first embodiment. Step S301 in which a preliminary check is performed, step S303 in which the exposure process is stopped, step S305 in which a test is conducted, and step S306 in which an exposure process is started in this embodiment are the same as in the prior art described with reference to FIG. 9, and a description thereof will not be given. Step S304 in which the control software is updated in this embodiment is also the same as in the first embodiment, and a description thereof will not be given, either. In step S302 of FIG. 5, the first information processing apparatus 8 acquires new control software, prior to updating the control software of the exposure apparatus 4 to the new control software. In this embodiment, the control software in the third information processing apparatus 10 is temporarily updated based on the control software in the second information processing apparatus 9 via the external communication network 3. The control software in the first information processing apparatus 8 is then updated based on the control software in the third information processing apparatus 10 using a medium.

An operation for updating the control software of the exposure apparatus 4 is more complicated but safety in terms of system security is higher in the second embodiment than in the first embodiment. Also, neither an operation for updating the control software of the exposure apparatus 4 on the exposure apparatus 4, nor medium transfer between the plant 1 and the vendor facility 2 is necessary, unlike the prior art.

### Third Embodiment

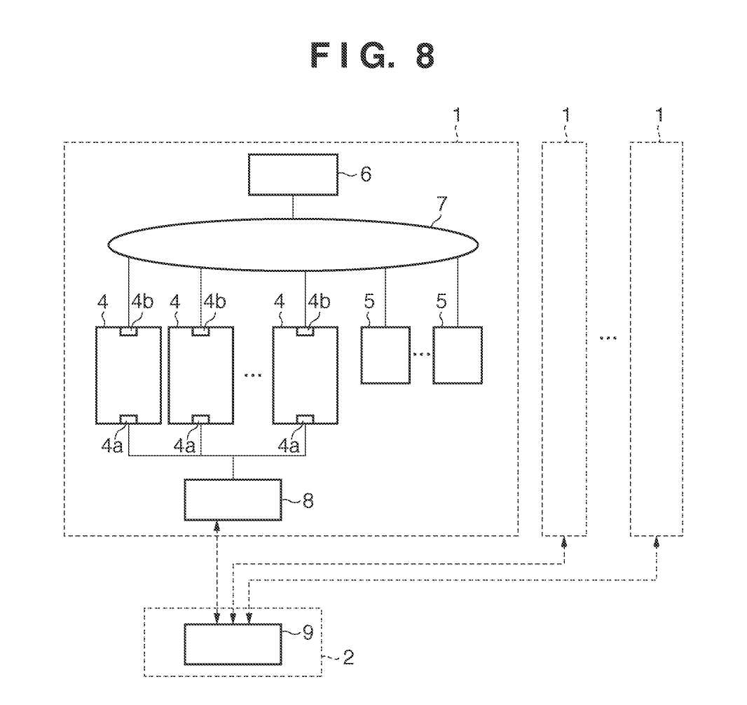

An exposure system including an exposure apparatus 4, and a method of updating the exposure apparatus 4 according to the third embodiment will be described with reference to FIG. 8. In the third embodiment, a first information processing apparatus 8 is connected to only one or more exposure apparatus 4, and is not connected to an external communication network 3. A second information processing apparatus 9 need not be connected to the external communication network 3, either. The first information processing apparatus 8 and second information processing apparatus 9 exchange control software using a medium such as a magnetooptical disk or a flexible disk. The system configuration is the same as in the first embodiment except for the above-mentioned features, and a description thereof will not be given. The first information processing apparatus 8 reads information on a medium from a medium drive, and updates the control software stored in a first storage unit 103. Also, the first information processing apparatus 8 transfers new control software to the exposure apparatus 4, and updates the old control software to the new control software, using a first communication unit 102. The second information processing apparatus 9 writes control software to be transferred to the first information processing apparatus 8 on the medium via the medium drive. In the third embodiment, since the first information processing apparatus 8 is not connected to the second information processing apparatus 9 via the external communication network 3, it acquires the control software, held in the second information processing apparatus 9, using a transportable medium. Hence, an operation for updating the control software of the exposure apparatus 4 is more complicated but safety in terms of system security can be higher in the third embodiment than in the first embodiment.

A method of updating the exposure apparatus 4 in the third embodiment will be described next with reference to FIG. 5, as in the first embodiment. Step S301 in which a preliminary check is performed, step S303 in which the exposure process is stopped, step S305 in which a test is conducted, and step S306 in which an exposure process is started in this embodiment are the same as in the prior art described with reference to FIG. 9, and a description thereof will not be given. Step S304 in which the control software is updated in this embodiment is also the same as in the first embodiment, and a description thereof will not be given, either. In step S302 of FIG. 5, the control software in the first information processing apparatus 8 is updated to target control software, prior to updating the control software of the exposure apparatus 4. In this embodiment, the first information processing apparatus 8 acquires new control software by updating the control software in the first information processing apparatus 8 based on the control software in the second information processing apparatus 9 using a medium.

An operation for updating the control software is more complicated but safety in terms of system security is higher in the third embodiment than in the first and second embodiments. Also, an operation for updating the control software of the exposure apparatus 4 on the exposure apparatus 4 is unnecessary, unlike the prior art.

A device manufacturing method using the exposure apparatus 4 shown in one of the first to third embodiments will be described next. In this case, a device is manufactured by a step of forming a pattern on a substrate using the exposure apparatus 4, and subsequent known steps. The device can be, for example, a semiconductor integrated circuit device or a liquid crystal display device. The substrate can be, for example, a wafer or a glass plate. The subsequent known steps include, for example, oxidation, film formation, vapor deposition, doping, planarization, dicing, bonding, and packaging steps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-186141, filed Aug. 10, 2009, which is hereby incorporated by reference herein in its entirety.

What is claimed is:

1. An exposure apparatus which exposes a substrate to radiant energy, the apparatus comprising:
a first interface connected to a communication network to which a control apparatus for performing a control operation of the exposure apparatus is connected;
a second interface connected, not via the communication network, to an information processing apparatus which updates a software installed on the exposure apparatus; and
a controller configured to control the first interface and the second interface so that communication of the first interface with the communication network is disabled, and thereupon communication of the second interface with the information processing apparatus is enabled to enable the information processing apparatus to update the software.

2. The apparatus according to claim 1, further comprising a storage configured to store a log of communication with the information processing apparatus.

3. A system including an exposure apparatus which exposes a substrate to radiant energy, and an information processing apparatus which updates a software installed on the exposure apparatus,
the exposure apparatus comprising:
a first interface connected to a communication network to which a control apparatus for performing a control operation of the exposure apparatus is connected;
a second interface connected, not via the communication network, to the information processing apparatus; and
a controller configured to control the first interface and the second interface so that communication of the first interface with the communication network is disabled, and thereupon communication of the second interface with the information processing apparatus is enabled to enable the information processing apparatus to update the software.

4. A method of updating a software, installed on an exposure apparatus which exposes a substrate to radiant energy, the method comprising:
the exposure apparatus switching states thereof so that communication with a communication network, to which a control apparatus for performing a control operation of the exposure apparatus is connected, is disabled, in response to a request from an information processing apparatus, and thereupon communication with the information processing apparatus is enabled; and
the information processing apparatus updating the software after the switching is performed.

5. A method of manufacturing a device, the method comprising:
exposing a substrate to radiant energy using an exposure apparatus;
developing the exposed substrate; and
processing the developed substrate to manufacture the device,
wherein the exposure apparatus comprises:
a first interface connected to a communication network to which a control apparatus for performing a control operation of the exposure apparatus is connected;
a second interface connected, not via the communication network, to an information processing apparatus which updates a software installed on the exposure apparatus; and
a controller configured to control the first interface and the second interface so that communication of the first interface with the communication network is disabled, and thereupon communication of the second interface with the information processing apparatus is enabled to enable the information processing apparatus to update the software.
